(19) United States
(12) Patent Application Publication
(10) Pub. No.: US 2012/0290262 A1
(43) Pub. Date: Nov. 15, 2012

(54) METHOD AND APPARATUS FOR MONITORING PERFORMANCE AND ANTICIPATE FAILURES OF PLANT INSTRUMENTATION

(75) Inventor: Mohad Azrin Bin MD Sani, Kerteh (MY)

(73) Assignee: Petrollam Nasional Berhad, Kuala Lumpur (MY)

(21) Appl. No.: 13/519,870

(22) PCT Filed: Dec. 29, 2010
(86) PCT No.: PCT/MY2010/000331

§ 371 Date: Jun. 28, 2012

(30) Foreign Application Priority Data
Dec. 31, 2009 (MY) PI20095691

(51) Int. Cl. G06F 17/18

(52) U.S. Cl. 702/181

(57) ABSTRACT

A method of detecting an unhealthy/potentially/failing instrument using apparatus is carried out by measuring a characteristic of the output of an instrument. The measurement of the characteristic is compared to an expected distribution of the instrument when healthy. The probability of the instrument producing such a characteristic measurement, or a value further from the mean of the expected distribution, if it was healthy is calculated. The measured characteristic to an expected distribution of the instrument when unhealthy is compared, and the probability of the instrument producing such a characteristic measurement, or a value further from the mean of the expected distribution, if it was unhealthy is calculated. The probability of the measured characteristic being produced by the instrument when healthy and when unhealthy is compared. A confidence value indicative of the likelihood of the instrument being unhealthy is then produced.

This invention relates to a method and apparatus for anticipating and/or detecting the failure of instruments.

Measuring-instruments such as analyzers and sensors, along with control valves and other field instruments, can fail over time. Typically maintenance of failed sensors only occurs a significant time after failure. The instruments will often have failed some time before their failure is noticed and consequently the data from them for an unknown length of time preceding the identification of the failure will be unreliable. In some cases the operation of the instrument is critical and any length of time in which it is unknowingly faulty can cause create problems in, for example, the running of an industrial plant.

Hi-tech analyzers, for example those that measure Oxygen, pH, purity, purity, moisture etc, can be very powerful tools in allowing the running of an industrial plant to be optimized. However, at present their lick of reliability and likelihood of failure means that their operators lose confidence in the data they provide. Consequently a significant percentage of analyzers are not utilized, and many more are only used for monitoring processes and not deemed reliable enough for optimizing those processes. At present in order to improve the situation the main option available is to increase maintenance of the analyzers. However maintenance is labor intensive and still may not always fix failing analyzers because it is not apparent the manner in which they are failing.

There are some known mathematical routines for detecting failed sensors for measuring process parameters such as those described in U.S. Pat. No. 5,680,409 and its introduction. However, these rely on providing sensor estimate signals which are often inaccurate, and only detect sensors once they deviate strongly from these estimates. Additionally such systems often wrongly identify sensors as failed when they are simply providing a routine error in measurement.

The situation can be improved if failure of sensors can be quickly detected or predicted before they occur.

It is an object of the present invention to mitigate at least some of the above mentioned problems.

According to an aspect of the invention there is provided method of detecting an unhealthy/potentially/failing instrument using apparatus comprising the steps of: measuring a characteristic of the output of an instrument, comparing the measurement of the characteristic to an expected distribution of the instrument when healthy, calculating the probability of the instrument producing such a characteristic measurement, or a value further from the mean of the expected distribution, if it was healthy, comparing the measured characteristic to an expected distribution of the instrument when unhealthy, calculating the probability of the instrument producing such a characteristic measurement, or a value further from the mean of the expected distribution, if it was unhealthy, comparing the probability of the measured characteristic being produced by the instrument when healthy and when unhealthy, and producing a confidence value indicative of the likelihood of the instrument being unhealthy.

According to another aspect of the invention there is provided apparatus adapted to detect an unhealthy/potentially/failing instrument, comprising a processor and memory, the processor programmed to determine or receive a value of a characteristic of the output of an instrument, to compare the value of the characteristic to an expected distribution of the characteristics of the instrument when healthy, to calculate the probability of the instrument producing such a characteristic measurement, or a value further from the mean of the expected distribution, if it was healthy, to compare the measured characteristic to an expected distribution of the instrument when unhealthy, to calculate the probability of the instrument producing such a value, or a value further from the mean of the expected distribution, if it was unhealthy, comparing the probability of the value being produced by the instrument when healthy and when unhealthy and to produce a confidence value indicative of the likelihood of the instrument being unhealthy.

According to another aspect of the invention there is provided a computer program product comprising computer executable instruction which when run on one or more computers provides the method described.

Further aspects and aims of the invention will become apparent from the appended claim set.

Embodiments of the invention will now be described, by way of example only, and with reference to following drawings in which:

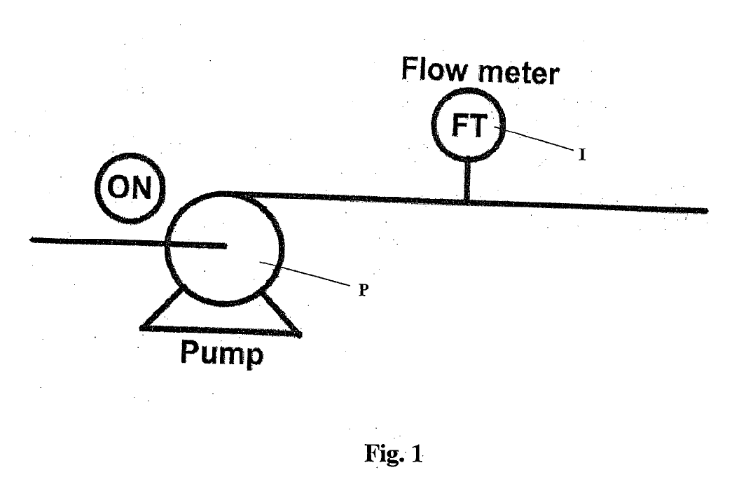

FIG. 1 is an illustration of an example of a measuring instrument and associated input device;

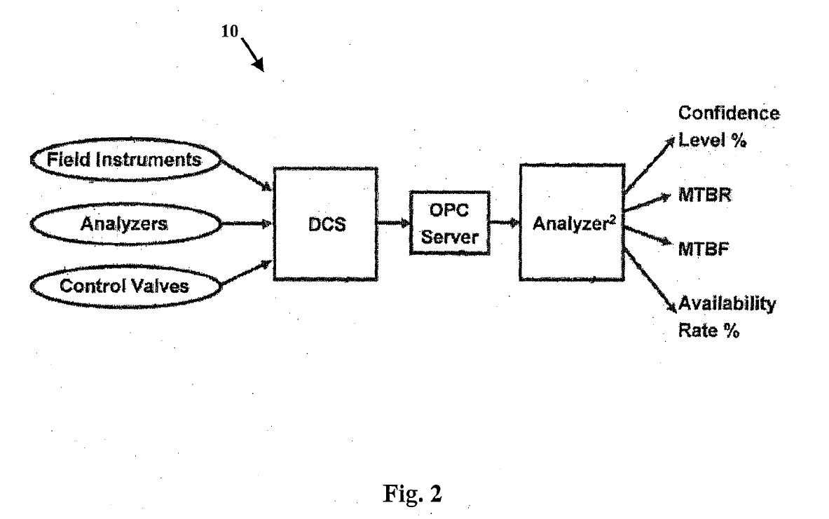

FIG. 2 is an illustration of analyzing apparatus 10 in accordance with invention;

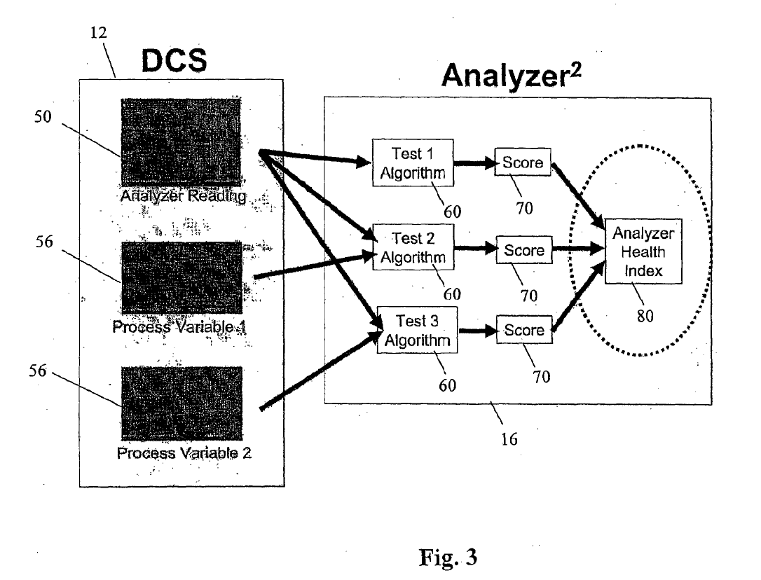

FIG. 3 is a flow process of providing a confidence health index in accordance with invention;

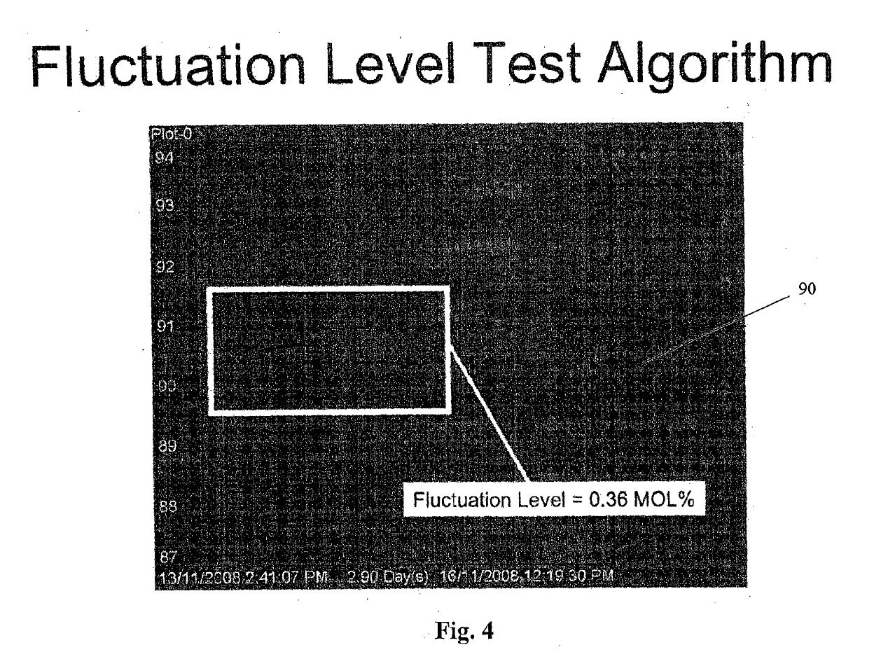

FIG. 4 is n illustration of fluctuating data from an analyzer;

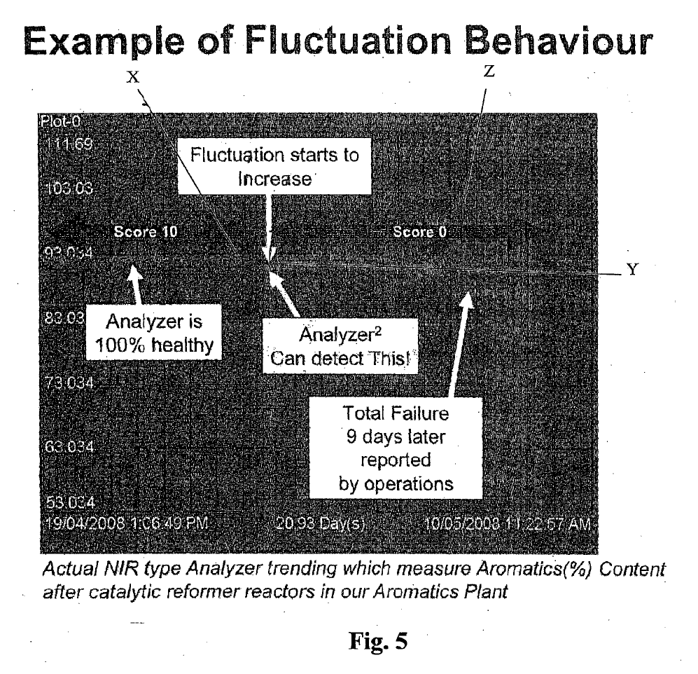

FIG. 5 is an illustration of past fluctuating data from a failed analyzer;

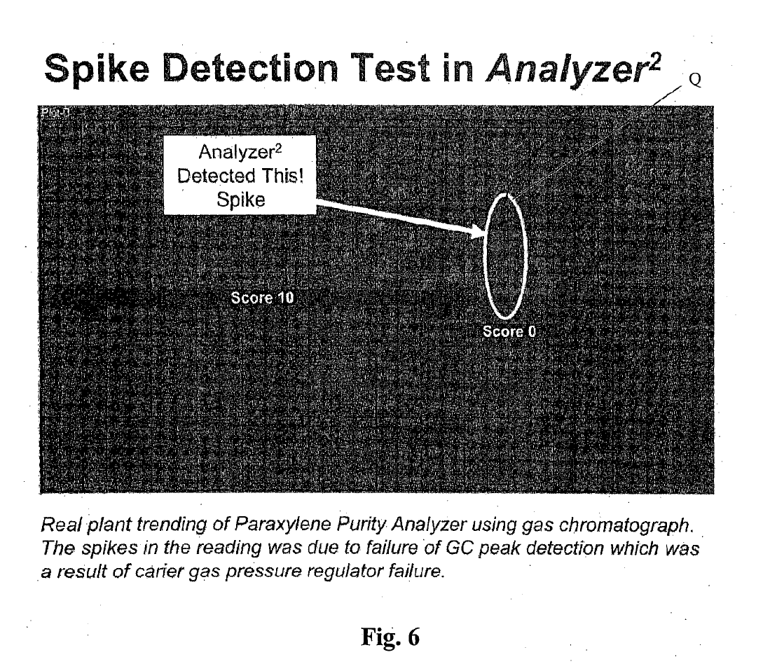

FIG. 6 is an illustration of data containing a spike;

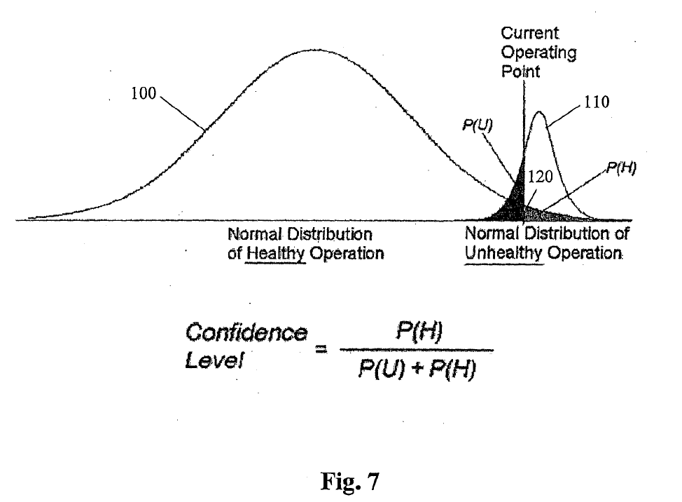

FIG. 7 is an illustration of probability distributions; and

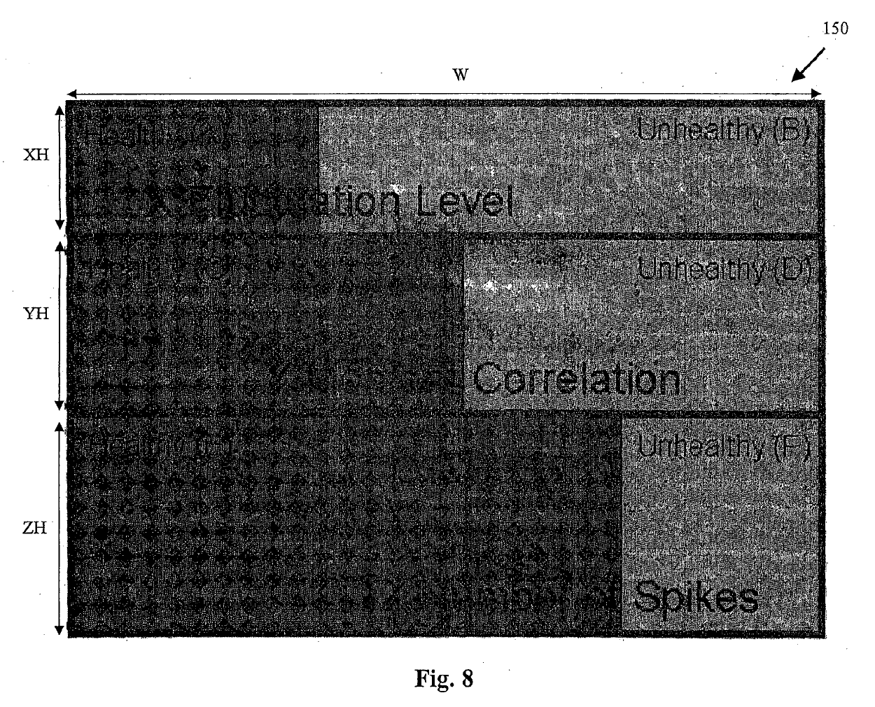

FIG. 8 is a Venn diagram of probabilities.

Referring to FIG. 1 there is shown an example of a measuring instrument I, which in this case is a flow meter. The measuring instrument I detects an output dependent on an input device. P, which in this case is a pump. The flow meter, instrument I, is measuring the rate of flow of fluid generated by the pump P.

In FIG. 2 is shown analyzing apparatus 10 in accordance with invention.

Analyzing apparatus comprises a Distributed Control System (DCS) 12, an OPC server 14 and an analyzing module 16.

The DCS 12 may be conventional. It takes its data from instruments I including field instruments, analyzers and control valves.

The DCS 12 sends its output data to the OPC server 14, which server may work in a conventional manner.

The server 14 outputs data in OPC format to the analyzing module 16. The analyzing module may comprise a computer with processor and memory. (memory being used to mean both RAM and data storage such as a hard drive), programmed to perform the processes and algorithms that will be described below.

Using these processes and algorithms, analyzing module 16 then provides outputs such as confidence level indicator that will be described below, along with the mean time between failure of a particular instrument (MTBF), the mean time between repair of a particular instrument (MTBR), and availability rate (the percentage of time a given instrument is always available). The confidence level indicator describes how confident the apparatus 10 is that a given instrument I is healthy. It is a simple value between 0 and 100% or as a decimal between 0 and 1. If the indicator reads 80% (or 0.8), it means that it is 80% confident that the instrument is healthy. In a predictive maintenance program, the confidence level indicator should prompt maintenance personnel to check the instrument if the indicator drops below a predetermined value such as 95%. The MTBF can then either classify a failure as an instance when the instrument fell below this value or when it is confirmed as failed/failing by maintenance personnel.

These outputs may be output to a display screen and/or or sent to other computers, or computer programs for further analysis and actions.

As an alternative the analyzing module 16 may be implemented solely in hardware such as in silicon circuits.

Before a measuring instrument I fails, it will exhibit some distinct behavior. These behaviors may include a sudden increase in reading fluctuations, spikes in reading, or slow response to plant processes.

The analyzing module 16 runs algorithms which use the data from the OCS server 14 (originating from the instruments I) and is able to predict the state of an instrument by analyzing its trend behavior. By detecting pre-failure behavior of instruments, it is possible to anticipate a failure before it actually happens.

In use the analyzing module 16 takes data from an instrument I (via DCS 12 and server 14) over a predetermined length of time to act as a sample to be analyzed. This sample size/length can be varied but too small a sample can increase the chance of the apparatus 10 not observing any pattern and taking too large a sample will have an averaging effect on the analysis which can reduce or cancel out a discrete pattern. Three hours has been found to be a suitable length of time for many instruments I.

The frequency of the sampling is also predetermined but can be varied. Preferably the sampling frequency follows Nyquists sampling theorem such that the sampling frequency is at least twice the observable pattern frequency. A high sampling frequency will generally improve analysis but too high a frequency can run into bandwidth issues on a computer network and therefore the upper limit is dependent on the physical hardware used as part of analyzing apparatus 10. For slow moving instruments such as process analyzers, it is efficient to use a low sampling frequency. For most instruments a 5 seconds interval is found to be suitable but for slow moving instruments, a one minute interval or data is adequate and with consequent benefits in reducing bandwidth and computer processing.

Referring to FIG. 3 there is shown a process of providing a confidence health index. For each instrument (in this instance analyzers) a series of readings 50 and process variables 56 are taken at the DCS 12 and one or more test algorithms 60 are applied to them by the analyzing module 16. Each of the algorithms 60 produce a different score 70 for each instrument/analyzer I which are combined to provide a single confidence health index 80 for each instrument I.

In the illustrated example an analyzer reading 50 is provided to three different algorithms 60. One of these algorithms 60 uses this reading 50 in isolation and the other two use it in conjunction with the measurements of a process variables 56 that are believed to be associated with the instrument I in some way.

The test algorithms 60 can include six different algorithms a/Fluctuation level, b/Fluctuation period, c/Number of Spikes d/Value e/Deviation and f/Moment Correlation, which will not all be appropriate for every instrument.

The scores 70 each comprise a pattern strength indicator and an algorithm confidence level. The pattern strength indicator is produced by test algorithm 60, the format of which may vary between algorithms 60. The algorithm confidence level is an indicator of the probability of the instrument I being healthy (or unhealthy/failing or failed) which can be expressed in a variety of ways such as a percentage or a decimal ranging from 0 to 1.

The health index 80 represents the percentage chance that the instrument I is healthy based on all of the test algorithms 60 and can be expressed in a similar format to the algorithm confidence levels.

Taking each of the six pattern recognition test algorithms 70 in turn:

a/Fluctuation

Referring to FIG. 4 it can be seen that there are fluctuations in the data 90 from an instrument I and therefore a level of fluctuation.

It has been found that patterns in the level of fluctuation can be used to anticipate instrument failure in many instances. Healthy instruments can be expected to fluctuate between certain levels. Too large or too small fluctuations may indicate unhealthy instruments

The analyzing apparatus 10 calculates fluctuation level by averaging the peak to peak fluctuation of a trend in the sample. The output pattern strength indicator as part of score 70 is the magnitude of this average peak to peak fluctuation. An example of this algorithm 60 is shown as follows:—

```
Up Peak counted = False
Down Peak counted = False
Go through each data in sample,
    If current data > last data, then
        Down peak counted = false
        Total Up Move = total up move + (current
        data − last data)
        If up Peak Counted = False then
            Total Peak = Total Peak + 1
            up Peak Counted = True
        End if
            End If
    If current data < last data, then
        Up peak counted = false
        Total Down Move = total down move +
        (current data − last data)
        If Down Peak Counted = False then
            Total Peak = Total Peak + 1
            Down Peak Counted = True
        End if
            End If
Fluctuation Level = (Total Up Move + Total Down
Move) / Total Peak
```

This is used to produce the output pattern strength indicator which in turn can be used to produce a confidence level as explained later.

In FIG. 5 can be seen a fluctuating trend of instrument data where the horizontal axis represents time. The analyzer in this case is an NIR analyzer which measures the percentage aromatics content after catalytic reformer reactions in an aromatics plant.

At point in time Z the analyzer I has been reported as completely failed by operational staff who have worked in a conventional manner. The data after point Z can be seen to be unusual in the extent of its fluctuation.

Up until point X the fluctuation level test algorithm produced a score close to 100% (or exactly 1.0 to the nearest two significant figures) so on the basis of these fluctuations levels the analyzer was working well. However after point Y the change in fluctuation levels has resulted in the score dropping to 0.0 (to 2 significant figures) indicating that a fault is very likely. Importantly point Y occurred nine whole days before point Z indicating that apparatus 10 can be very powerful at predicting failures in advance of their detection. In fact the score had been falling from 1 (or 100%) to 0 for the time between X and Y allowing even earlier detection.

b/Fluctuation Period Algorithm

The fluctuation level algorithm, analyzes the fluctuation period of an instrument. Healthy instruments can be expected to fluctuate between certain periods. Too large or too small fluctuation periods may indicate unhealthy instruments. The analyzing module 16 calculates fluctuation period by averaging the upper peak to upper peak period of a trend. The output pattern strength indicator is the average fluctuation period. An example of the algorithm 60 is shown as follows: —

```
Up Peak Counted = False
Down Peak counted = False
Go through each data in sample,
    If current data > last data, then
        Down peak counted = false
        Total Up Period = Total up Period +
        (current data timestamp − last data
        timestamp)
        If up Peak counted = False then
            Total Peak = Total Peak + 1
            Up Peak counted = True
        End if
            End If
    If current data < last data, then
        Up peak counted = false
        Total Down Period = Total Down Period +
        (current data timestamp − last data
        timestamp)
        If Down Peak Counted = False then
            Total Peak = Total Peak + 1
            Down Peak Counted = True
        End if
            End If
Fluctuation Period = 2 × (Total up Period + Total
Down Period) / Total Peak
```

Again the output pattern strength indicator is used to produce a confidence level.

c/Spike

A spike is a sudden increase (or decrease) in an instrument reading. It has been found that healthy instruments do not spike and that a spike is a good pre-indication that at instrument is going to fail.

In preferred embodiments the apparatus 10 identifies a spike if a data trend satisfies two conditions:—

1/The instrument reading jumps higher than 2.5 times it's long term average fluctuation level. 2.5 times fluctuation level, is more or less similar to four times standard deviation. Four standard deviations will cover 99.994% of actual process values. The remaining 0.006% is the probability that a spike may be an actual process (i.e. not indicative of instrument failure). The long term average fluctuation is measured similarly to the fluctuations using the fluctuation level algorithm (a/above) but is preferably taken from a long term sample described below.

Using a higher standard deviation coefficient will give an even more accurate spike but may run into possibility of reaching the instrument's maximum range. If the instruments reaches it's maximum range, the spike detection algorithm will not count anything higher than it.

2/The jump takes place within half of a long fluctuation period.

Long fluctuation level/period is the fluctuation level/period calculated using the fluctuation level/period algorithm described above. The only difference is that instead of using the current sample, the longer time sample is used. It is reasonable to start at a default 15 day sample to obtain this long fluctuation level/period.

Conventionally, a spike is often described as a sudden increase which is immediately followed by a sharp decrease in a reading. However, the spike algorithms will generally define a spike only as the sudden increase/decrease part. If such increase is followed by a decrease, it will detect this as another spike. Hence giving two spikes in the reading.

The output pattern strength indicator is based on and is preferably equal to the Number of Spikes in the short sample. An example algorithm 60 is shown as follows

```
SL = 4 × Long fluctuation level
            ‘Spike Limit
PL = 0.5 × Long fluctuation Period / Data Sampling Period ‘Period
Limit
IF PL ≦ 1 then PL = 1
Go through each data in sample,
    CD = Current Data
    Spike Detected = False
        Go through the next data in sample,
            ND = Next Data
            Spike = Spike + (CD − ND)
            If (Absolute Value(Spike) > SL) then
                Spike Detected = True
                Number Spike = Number Spike + 1
            End If
            Data Counter = Data Counter + 1
          Repeat until (Data Counter ≧ PL) OR (spike
Detected)
        Data Counter = 0
  End Repeat
```

In FIG. 6 is shown real plant trending of Paraxylene Purity Analyzer using a gas chromatograph.

Spikes such as the one at point Q were detected by apparatus 10 which were due to failure of GC peak detection which was in turn a result of carrier gas pressure regulator failure.

d/Value

With a stable plant process, a healthy instrument can be expected to read within certain values. For example, furnace excess Oxygen should typically be around 1 to 7%. The Value algorithm constantly monitors a moving average of the instrument reading. If the reading does not read within an expected range, the instrument may be considered faulty. The algorithm calculates the average. The output pattern strength indicator is the Average Value

```
CD = Current Data
Go through each data in sample,
    Total = Total + CD
        Data Counter = Data Counter + 1
    Average Value = Total / Data Counter
```

e/Deviation

The deviation algorithm takes readings form two similar instruments I and calculates the average deviation between the two instruments. Two similar instruments measuring the same point should have a standard allowable average deviation. The algorithm is demonstrated as follows. The output pattern strength indicator is the Average Deviation:
CD1=Current Data 1
CD2=Current Data 2
Go through each data in sample,

Total=Total+(CD2−CD1)
Data Counter=Data Counter+1

Average Value=Total/Data Counter

f/Moment Correlation Algorithm

This has been found to be perhaps the most powerful algorithm 60 and is perhaps the most successful when used in isolation across a number of different instrument types.

The moment correlation algorithm measures the moment correlation between a particular instrument and other process variables. For example:

steam flow should correlate with the rate of change of temperature;
rate of level drop in a vessel should correlate with downstream flow rate.

This algorithm will require two sets of data one of which is typically instrument readings and one is typically a process variable.

Module 16 uses a variation of Pearson's product moment correlation coefficient formula. The output pattern strength indicator is the correlation coefficient, the formula being as follows: —

$$r = \frac{1}{n - 1} {\sum }_{i = 1}^{n} ( \frac{{X}_{i} - \overline{X}}{{s}_{X}} ) ( \frac{{Y}_{i} - \overline{Y}}{{s}_{Y}} ) \qquad [ Equation 1 ]$$

### r is the Correlation Coefficient

s is long standard deviation. The standard deviation is not calculated from the sampled data on which the algorithms 60 are applied, but calculated from a longer time called the ‘long sample data’. Again as a default value, a fifteen day sample would be good enough. The purpose of dividing with standard deviation is to have a ‘zoom’ effect or normalization on the data to the correlated. This is because the data's absolute values are different in measuring units or magnitudes. So, instead of looking at absolute values, it is more appropriate to look into it's relative to standard deviation,
X is a sample in the data set,
X with bar is the sample average and n is the sample size

The algorithm 60 can be based on the Equation 1 formula.

Equation 1 will produce a conventional correlation coefficient ranging from 0 (no correlation) to 1 (full correlation). Since a correlation is expected in a healthy instrument a coefficient that is decreasing may indicate a failing instrument. The coefficient or change in the coefficient is converted to a score between 0 and 10 to be compared to the other output values.

Equation 1 may not be suitable at all times for all instruments and processes. This is because if the process does not change, little change will be expected in the instrument data and the instrument's natural fluctuation frequency will be the dominate change. Since instrument's natural fluctuation frequency is independent of the process the result of equation 1 will be a near zero correlation coefficient even though the instrument I may be perfectly healthy.

For example flow meter I in FIG. 1 may fluctuate between 2-4 m³/hr when it's healthy. If the pump P stops pumping, the flow meter will no longer fluctuate. In this case, if the fluctuation algorithm is applied, it will not detect any fluctuation and hence give a low confidence level score on the flow meter's healthiness. This would be an inaccurate judgment on the flow meter.

To avoid this a trigger condition can be used. The trigger condition is to ensure that the algorithm does not execute if there is no movement change in the trend so the trigger condition identifies a movement in trend. In the example of FIG. 1 the condition will be set in a way so that if the pump is not pumping, the fluctuation level algorithm should not be executed. A suitable trigger condition is found to be when the difference between highest and lowest value in the sample is larger than twice it's “long” standard deviation s.

An example of a trigger condition algorithm is as follows:
A=highest value in data 1
B=lowest value in data 1
C=highest value in data 2
D=lowest value in data 2
s=long standard deviation
If [(A-B)>2s] OR [(C-D)>2s] then Calculate correlation coefficient of sample

The moment correlation test algorithm can also be adapted to be applied to situations where there are more than 2 data sets such as when two process variables are relevant.

Each set of data does not need to go through all pattern recognition algorithms. Some pattern recognition algorithms may not be applicable for that particular instrument. One example is the moment correlation and average deviation algorithm. These algorithms require two sets of data. Some instruments work independently. They have no correlation to any other instruments. It is therefore not sensible also to run the algorithm on that instrument.

Referring back to FIG. 3 the first part of output scores 70, the pattern strength indicators, have been produced by the test algorithms 60.

The next stage is to use these values to determine a likelihood that the instrument is failing.

The horizontal axis in FIG. 7 represent the reading on the particular instrument I or operating point. The vertical axis represents the probability of the reading/point occurring. In FIG. 7 there is shown a healthy probability distribution function 100 for when the particular instrument I is healthy and the unhealthy probability distribution 110 for when it is not. As illustrated in FIG. 7, these two functions 100 and 110 are each represented by bell curve/Gaussian produced by a normal distribution. In theory, the confidence level of healthiness is an approximation of an operation between these two probability distribution functions.

At any specific instrument reading or operating point, there is a probability that an instrument is healthy P(H) and a probability than an instrument is unhealthy P(U). The confidence level is the relative portion of P(H) against P(H)+P(U) i.e. can be represented by the equation

Confidence Level=P(H)/P(H)+P(U)

Once P(H) and P(U) have been obtained, it is therefore easy to calculate the confidence level. Since there will be several algorithm confidence levels from each different pattern recognition algorithms 60, in preferred embodiments these are integrated/combined as the confidence health index 80. Methods of doing so are explained below.

Sometimes there is more than one unhealthy probability distribution function for the same algorithm. One example is the fluctuation level. A particular instrument can be in an unhealthy state when it is fluctuating heavily and when failing slowly. In these case two confidence levels will be calculated which can also be combined/integrated as will be explained later on.

A theoretical normal distribution has endless limits. However, some pattern strength indicators are limited in values, so the normal distribution is truncated or stopped at these limits. Since the full area integration of a normal distribution (from −infinity to +infinity) must always be 1 (or 100%) the full area integration must still be 100% after the truncation.

| Pattern | |
|---|---|
| Recognition | |
| Algorithm | Probability Distribution Function |
| Moment | Normal Distribution truncated at +1 and −1 |
| Correlation | |
| Fluctuation Level | Normal Distribution Truncated at 0 |
| Fluctuation Period | Normal Distribution Truncated at 0 |
| Average Value | Normal Distribution Truncated at 0 if such value is |
| | impossible to be zero (e.g. length, Kelvin, flow rate |
| | and etc) |
| Average Deviation | Normal Distribution without truncation |
| Spike Detection | Binomial Distribution Truncated at 0 |

The spike detection algorithm produces a discrete pattern strength indicator (number of spikes) and therefore uses the discrete equivalent of normal distribution function which is the binomial distribution function.

A Binomial distribution is based on the number of successes in a series of independent observations. Each spike is considered a “success”. The number of observations, n, will be the sample size divided by fluctuation level.

$$Pr ( K = k ) = ( \begin{matrix}n \\ k\end{matrix} ) {{p}^{k} ( 1 - p )}^{n - k} \\ for k = 0 , 1 , 2 , … , n and where \\ ( \begin{matrix}n \\ k\end{matrix} ) = \frac{n !}{k ! ( n - k ) !} \qquad [ Equation 2 ]$$

Where n is the sample size divided by fluctuation period, k is the number of spikes, Pr is the Probability of spike, P is the Probability of reading to go higher than four tithes standard deviation or 2.5 times fluctuation level (this value is 0.007% for the probability distribution function when healthy).

P should be equal to 0.006% because this is probability of an event happening that's higher than four times the standard deviation and this is how a “spike” has been defined i.e. it is the probability of a healthy instrument producing a spike.

As an example it may be found that an instrument reading spikes a single time in the sample data. We first calculate P(H) using the formula above. Referring to FIG. 7, a healthy operation, P(H) is the total area of the right hand side of the curve. The curve is crossed by the current operating point. In this case, the current operating point is ‘1 spike’·P(H) can thus be calculated by adding up all the values for P(2) up to P(n) or more simply it is just 1−P(1)−P(0).

In order to calculate the P(H) and P(U) and therefore the confidence level, the shape of the healthy and unhealthy probability distributions 102 and 104 should be known. This is can be produced by modeling based on past behavior.

For a binomial distribution the two parameters needed are n and P. The size of the sample n is easily determined and in the case of the spikes P is also easily determined from the definition of a spike.

For normal distributions the “long” standard deviation and the mean are either known or estimated.

For the healthy distribution 102 the long sample can be taken starting from the analysis date and running a predetermined number of days. For Example, to calculate the confidence level at Jun. 25, 2008 6:32 am. The long sample should start at Jun. 25, 2008 6:32 am and use data back on tome form this. If the long sample as 15 days, the sample size will therefore be from 15 to Jun. 25, 2008.

For the unhealthy probability distribution function 110, this is preferably deduced from an analysis of a long sample when the instrument reading is known to be faulty however, this is sometimes not practical since the instrument may not failed since installed. Even when historical data is present and the instrument is known to have failed, it may not be easy to identify the time when it failed suing conventional methods. Reference can be made to maintenance records but maintenance records are not always accurate.

Preferred embodiments use a default value system. It is possible to have standard default values for specific instrument applications. Example are:—a/Waste water treatment plant instruments, b/Reformer unit instruments, c/Boiler feed water instruments d/Furnace and boiler control instruments

Starting default value for each pattern recognition algorithm have been identified. This value can be used if little is known about how the specific instrument will behave when it's about to fail.

The table below lists down the source of the modeling parameters and it's starting default value:—

| | | | | Unhealthy |
|---|---|---|---|---|
| | | | | Probability |
| | | Healthy | | Distribution |
| | Probability | Probability | Unhealthy Probability | Function |
| Pattern | Distribution | D Function | Distribution Function | Standard |
| Algorithm | Function | Parameters | Mean | Deviation |
| Moment | Normal | Mean: | Sample a time when the | Sample a time |
| Correlation | Distribution | Long Sample | instrument is faulty | when the |
| | truncated at | Standard | OR | instrument is faulty |
| | +1 and −1 | Deviation: | Starting value = 0 | OR |
| | | Long Sample | | Starting value = |
| | | | | Standard deviation |
| | | | | when healthy |
| Fluctuation | Normal | Mean: | Sample a time when the | Sample a time |
| Level | Distribution | Long Sample | instrument is faulty | when the |
| | Truncated at 0 | Standard | OR | instrument is faulty |
| | | Deviation: | Starting value = Mean + | OR |
| | | Long Sample | 4 standard deviations | Starting value = |
| | | | (for unhealthy heavy | Standard deviation |
| | | | fluctuation), | when instrument is |
| | | | OR | healthy |
| | | | Starting value = Mean − | |
| | | | 4 standard deviations | |
| | | | (for unhealthy low | |
| | | | fluctuation). | |
| | | | Minimum value is 0. | |
| Fluctuation | Normal | Mean: | Sample a time when the | Sample a time |
| Period | Distribution | Long Sample | instrument is faulty | when the |
| | Truncated at 0 | Standard | OR | instrument is faulty |
| | | Deviation: | Starting value = Mean + | OR |
| | | Long Sample | 4 standard deviations | Starting value = |
| | | | (for unhealthy slow | Standard deviation |
| | | | fluctuation), | when instrument is |
| | | | OR | healthy |
| | | | Starting value = Mean − | |
| | | | 4 times standard | |
| | | | deviations. | |
| | | | Minimum value is 0. | |
| Average | Normal | Mean: | Sample a time when the | Sample a time |
| Value | Distribution | Long Sample | instrument is faulty | when the |
| | Truncated at | Standard | OR | instrument is faulty |
| | 0 if such | Deviation: | Starting value = Mean + | OR |
| | value is | Long Sample | 4 standard deviations | Starting value = |
| | impossible to | | (for unhealthy higher | Standard deviation |
| | be below | | value), | when instrument is |
| | zero (e.g. | | OR | healthy |
| | length, | | Starting value = Mean − | |
| | Kelvin, etc) | | 4 standard deviations | |
| | | | (for unhealthy lower | |
| | | | value) | |
| Average | Normal | Mean: | Sample a time when the | Sample a time |
| Deviation | Distribution | Long Sample | instrument is faulty | when the |
| | | Standard | OR | instrument is faulty |
| | | Deviation: | Starting value = Mean + | OR |
| | | Long Sample | 4 times standard | Starting value = |
| | | | deviation (for | Standard deviation |
| | | | unhealthy higher | when instrument is |
| | | | value), | healthy |
| | | | OR | |
| | | | Starting value = Mean − | |
| | | | 4 times standard | |
| | | | deviation (for | |
| | | | unhealthy lower) | |
| Spike | Binomial | p: | p: | n: |
| Detection | Distribution | 0.00007 | Sample a time when the | sample size divided |
| | Truncated at 0 | n: | instrument is faulty | by fluctuation |
| | | Sample size | | period |
| | | divided by | | OR |
| | | fluctuation | | Value = 1/n from |
| | | period | | healthy sample |

It is possible that the instrument I is showing healthy behavior, but it's confirmed to be unhealthy, or is showing unhealthy behavior but it's confirmed healthy. Whether this is the case can not be calculated in advance and therefore it is worth knowing the probability that these issues will come.

Referring back to FIG. 7 there can be seen an area of overlap between the healthy and unhealthy distribution 100 and 110 that is the area below curves delimited by both distribution 100 and 110. This area in fact represent the probability of showing unhealthy behavior but it's confirmed healthy. This value can be denoted as P(UB|H). The same areas is also the probability that it's showing a healthy behavior when it's confirmed unhealthy which can be denoted as P(HB|U). Since the total area of the bell curves is always equal to 1, P(UB|H)=P(HB|U).

This area 120 can be calculated by an algorithm performed by apparatus 10 as follows
x is the value at the intersection
CDF(a, b, c) is the cumulative distribution function with
   a=value at x-axis of normal distribution
   b=mean of normal distribution
   c=standard deviation of normal distribution
m=mean of healthy behavior
d=standard deviation of healthy behavior
n=mean of unhealthy behavior
e=standard deviation of unhealthy behavior
Y=A flag that indicates the mean of an unhealthy distribution is most likely to be higher than a healthy one.
a=d [symbol] 2−e [symbol] 2
b=−2×(n×d [symbol] 2−m×e [symbol] 2)
c=n [symbol] 2×d [symbol] 2−m [symbol] 2×e [symbol] 2−2×d [symbol] 2×e [symbol] 2×ln(d/e)
If Y=True, x=(−b+root(b [symbol] 2-4×a×c))/(2×a)
If Y=False, x=(−b−root(b [symbol] 2-4×a×c))/(2×a)
If d=e, x=(m [symbol] 2−n [symbol] 2)/(2*(m−n))
If Y=True, Area=CDF(m−abs(x−m), m, d)+CDF(x, n, e)
If Y=False, Area=CDF(n−abs(x−n), n, e)+CDF(x, m, d)

Referring to FIG. 8 there is shown a Venn Diagram 150 of a particular instrument I's behavior. The Venn diagram 150 is a snapshot of a particular analysis time. The diagram includes three confidence levels which have been calculated from three different algorithms, these are fluctuation level X, Moment correlation Y and Number of Spikes confidence Z with the probabilities of each of being healthy or unhealthy for each of X, Y, Z represented by six rectangles A, B, C, D, E and F.

The widths of X, Y and Z are each the same and represent a value of 1 or 100% depending on the value used for the algorithm confidence levels. The points along the width W at which unhealthy rectangle A, D and E end and healthy rectangles B, D and F starts is equal to the value of the respective algorithm confidence levels.

The heights XH, YH and ZH are different for each algorithm 60. In order to present the relative reliability of each algorithm the height represents the probability that the analyzed behavior matches the confirmation of the instrument being healthy or unhealthy i.e 1-2×P(UB|H). This can be calculated in each case from the area 120 using the algorithm described above. The test algorithms 60 with large overlap between the healthy and unhealthy distributions 100 and 110 will be deemed less reliable.

Each height XH, YH, ZH does of course remain the same for, the healthy and unhealthy rectangle from the same test algorithm 60 so that:

The confidence level for Fluctuation Level P(H|X)=A/(A+B)
The confidence level for Moment Correlation P(H|Y)=C/(C+D)
The confidence level for the Spike Number P(H|Z)=E/(E+F)

The overall confidence health index 8—will be the total chance of being healthy. From Bayesian probability theorem, the overall probability P(H) can be derived as follows: —

P(H)=P(H|X)·P(X)+P(H|Y)·P(Y)+P(H|Z)·P(Z)

P(H|X), P(H|Y) and P(H|Z) have been determined above but the values of P(X), P(Y) and P(Z) are also needed.

P(X)+P(Y)+P(Z)=1·P(X), P(Y), and P(Z) is the probability between each other. i.e. P(X)=X/(X+Y+Z)·P(Y)=Y/(X+Y+Z) and P(Z)=Z/(X+Y+Z). These values inform the probability that a pattern exists in the current snapshot of the instrument reading. Since the width W is the same in each case P(X)=XH/(XH+YH+ZH)·P(Y)=YH/(XH+YH+ZH) and P(Z)=ZH/(XH+YH+ZH).

Accordingly P(H) the overall health index 80 can be calculated.

In a predictive maintenance program the value of P(H) can then be used to determine if the instrument I should be serviced immediately or to adjust the next date when it will be maintained operators of an industrial plant may decide that for any instruments for which P(H)<0/05 (5%) that it should be treated as a failed instrument. In alternative embodiments single algorithm confidence levels may be used in a similar way. Where multiple algorithms 60 are used, rather than combining them, each can be used for a threshold test but this will likely create more examples of false detection of faulty instruments than if the combined index 80 is used,

1. A method of detecting an unhealthy instrument comprising the steps of:
measuring a characteristic of an output of an instrument;
comparing the measurement of the characteristic to an expected distribution of the instrument when healthy;
calculating the probability of the instrument producing such a characteristic measurement, or a value further from the mean of the expected distribution, if it was healthy, comparing the measured characteristic to an expected distribution of the instrument when unhealthy;
calculating the probability of the instrument producing such a characteristic measurement, or a value further from the mean of the expected distribution, if it was unhealthy; and
comparing the probability of the measured characteristic being produced by the instrument when healthy and when unhealthy, and producing a confidence value indicative of the likelihood of the instrument being unhealthy.

2. A method according to claim 1, wherein the confidence value is calculated from the ratio of the probability of the measured characteristic being produced by the instrument when healthy or the probability when unhealthy with the sum of the probabilities of the measured characteristic being produced by the instrument when healthy and of being produced when unhealthy.

3. A method according to claim 1, wherein the characteristic measurement is produced from monitoring output over a length of time.

4. A method according to claim 1, wherein at least one expected distribution is produced from the output of the instrument or a similar instrument when known to be healthy or to be unhealthy over a period of time.

5. A method according to claim 3, wherein the period of time over which the sample data is taken to produce the expected distribution is significantly longer than the length of time over which the characteristic is measured for comparison to the expected distribution.

6. A method according to claim 1, wherein at least one expected distribution is a normal distribution.

7. A method according to claim 1, wherein the standard deviation of the unhealthy expected distribution is at least initially taken to be substantially equal to the standard deviation of the healthy expected distribution.

8. A method according to claim 1, wherein the mean of the unhealthy expected distribution is at least initially taken to be substantially equal to the standard deviation of the healthy expected distribution plus or minus a predetermined, preferably integer, coefficient multiplied by the standard deviation.

9. A method according to claim 1, wherein the characteristic is a discrete number of instances of an event occurring.

10. A method according to claim 9, wherein the classification of the event occurring is measured in terms of a standard deviation of another measurable characteristic of the output.

11. A method according to claim 9, wherein at least one expected distribution is calculated as a binomial distribution based on likelihood of the instance of the event occurring.

12. A method according to claim 11, wherein the probability used for the binomial distribution of the unhealthy expected distribution is taken to be substantially equal to the probability used for the binomial distribution of the healthy expected distribution.

13. A method according to claim 11, wherein the number of the sequence of independent yes/no experiments used for the binomial distribution of the unhealthy expected distribution is taken to be the reciprocal (multiplicative inverse) of the number of the sequence of independent yes/no experiments used for the binomial distribution of the healthy expected distribution.

14. A method according to claim 1, wherein the characteristic is a measure of the amount by which the output of the instrument fluctuates.

15. A method according to claim 14, wherein the characteristic is or corresponds to the average of peak to peak fluctuation of a trend.

16. A method according to claim 9, wherein the characteristic is a measurement of a number of spikes, when the output increases or decreases significantly faster or with greater magnitude than usual.

17. A method according to claim 1, wherein the characteristic is or corresponds to a rolling average of the output of the instrument.

18. A method according to claim 1, wherein the characteristic is the average time period in which the output of the instrument fluctuates between two values.

19. A method according to claim 1, wherein the characteristic is a measure of deviation between two instruments.

20. A method according to claim 1, further comprising the step of measuring a process parameter which can be expected to correlate with the output of the instrument when healthy, and wherein the characteristic is at least partially based on correlation between the output of instrument and the measured process parameter.

21. A method according to claim 20, wherein the characteristics measurement is a correlation coefficient.

22. A method according to claim 1, wherein the output is only measured or used to contribute towards the characteristic value when a trigger condition has been met.

23. A method according to claim 22, wherein the trigger condition is based on one or more of the variation in output increasing above a predetermined magnitude or an associated device's activity level.

24. A method according to claim 1, wherein the steps of calculating and comparing are repeated for a plurality of characteristics providing a plurality of confidence of values.

25. (canceled)

26. A method according to claim 24, further comprising the step of comparing confidence values for different characteristics and providing an overall confidence value.

27. A method according to claim 26, wherein the step of producing the overall confidence level combines the characteristic confidence levels weighted based on the likelihood of them reporting unhealthy behavior when the instrument is confirmed healthy or vice versa and/or the size of the overlap of the healthy and unhealthy expected distributions.

28. A method according to claim 1, wherein the instrument is an analyzer.

29. An apparatus adapted to detect an unhealthy instrument, comprising a processor and memory, the processor programmed to
determine or receive a value of a characteristic of an output of an instrument;
compare the value of the characteristic to an expected distribution of the characteristics of the instrument when healthy;
calculate the probability of the instrument producing such a characteristic measurement, or a value further from the mean of the expected distribution, if the instrument was healthy;
compare the measured characteristic to an expected distribution of the instrument when unhealthy;
calculate the probability of the instrument producing such a value, or a value further from the mean of the expected distribution, if it was unhealthy; and
compare the probability of the value being produced by the instrument when healthy and when unhealthy and to produce a confidence value indicative of the likelihood of the instrument being unhealthy.

30. A non-transitory computer readable media containing computer executable instructions which when run on one or more computers provides a method according to claims 1.
